(19) United States
(12) Patent Application Publication
(10) Pub. No.: US 2025/0165035 A1
(43) Pub. Date: May 22, 2025

(54) CAPTIVE SEAL TRIM

(71) Applicant: Google LLC, Mountain View, CA (US)

(72) Inventors: David Scott Moore, Mountain View, CA (US); Avi Pinchas Hecht, San Francisco, CA (US)

(21) Appl. No.: 18/514,917

(22) Filed: Nov. 20, 2023

(51) Int. Cl. G06F 1/16

(52) U.S. Cl. CPC G06F 1/1656

(57) ABSTRACT

An example computing device includes a housing, wherein the housing includes a slot along at least a portion of an interior side of the housing; a panel; and a trim subassembly, wherein the trim subassembly includes a non-compliant component and a compliant component, wherein at least a portion of the non-compliant component is attached to the panel, wherein the compliant component is inserted into the slot of the housing, and wherein the compliant component is disposed between one or more sides of the non-compliant component and the housing.

### TECHNICAL FIELD

This disclosure relates to computing devices, and, more specifically, to housings of computing devices

### BACKGROUND

Computing devices, such as smartphones, laptops, wearable devices, and tablets, may include a housing to which a panel is attached. The computing devices may include one or more panels made of glass such as the backing on a phone and a glass panel that covers a display of the computing device. The panels can be attached to the computing device using strips of adhesive.

### SUMMARY

In general, aspects of this disclosure are directed to a trim subassembly that attaches a panel to an electronic device and includes a component that holds the trim subassembly to the electronic device. For instance, the trim subassembly may include a non-compliant component attached to the panel and a compliant component that is inserted into a slot of the housing the electronic device. In this way, the trim subassembly may hold the panel in place against the housing of the electronic device though the compliant component.

In one example, a computing device includes a housing, wherein the housing includes a slot along at least a portion of an interior side of the housing; a panel; and a trim subassembly, wherein the trim subassembly includes a non-compliant component and a compliant component, wherein at least a portion of the non-compliant component is attached to the panel, wherein the compliant component is inserted into the slot of the housing, and wherein the compliant component is disposed between one or more sides of the non-compliant component and the housing.

In another example, a method includes attaching a panel to a trim subassembly, wherein the trim subassembly includes a non-compliant component and a compliant component, wherein at least a portion of the non-compliant component is attached to the panel; and inserting the trim subassembly into a slot of a housing of a computing device, wherein the slot is located along at least a portion of an interior side of the housing, and wherein the compliant component is disposed between one or more sides of the non-compliant component and the housing.

In yet another example, a kit for attaching a panel to a housing of a computing device includes the panel, wherein the panel is attached to a trim subassembly, wherein the trim subassembly includes a non-compliant component and a compliant component, wherein at least of a portion of the non-compliant component is attached to the panel; and a housing, wherein the housing includes a slot along at least a portion of an interior side of the housing, wherein the compliant component is inserted into the slot of the housing, and wherein the compliant component is disposed between one or more sides of the housing.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a perspective view schematic diagram illustrating a cross-section of a housing of a device, in accordance with one or more aspects of this disclosure.

FIG. 2A is a side view schematic diagram illustrating a cross-section of a portion of a housing of a device, in accordance with one or more aspects of this disclosure.

FIG. 2B is a side view schematic diagram illustrating a cross-section of a portion of a housing of a device, in accordance with one or more aspects of this disclosure.

FIG. 3 is a side view schematic diagram illustrating a cross-section of a portion of a housing of a device that includes a fastener, in accordance with one or more aspects of this disclosure.

FIG. 4 is a flow chart illustrating a method of forming an assembly of a device, in accordance with one or more aspects of this disclosure.

### DETAILED DESCRIPTION

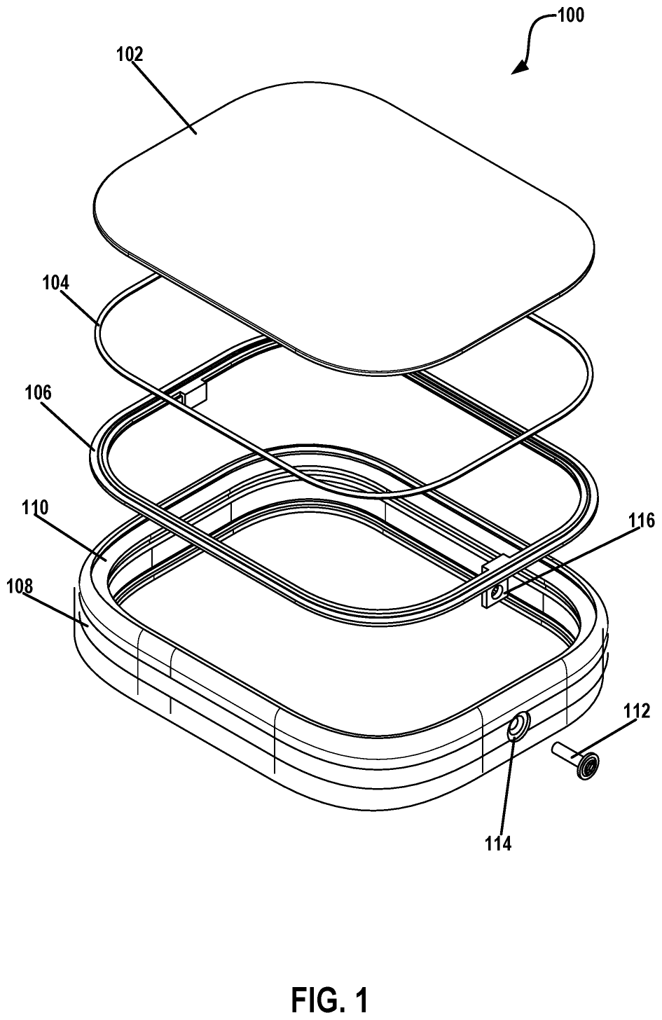

FIG. 1 is a perspective view schematic diagram illustrating a cross-section of a housing of a device, in accordance with one or more aspects of this disclosure. Examples of device 100 may include computing devices such as smartwatches, tablets, smartphones, portable gaming devices, fitness trackers. Other examples of device 100 include automotive head units, laptop computing devices, and other computing devices that include a display. Device 100 may also include computing devices that include a panel that is attached to the housing of the computing device.

Device 100 includes a housing 108. Housing 108 may be a housing for one or more components of device 100 such as circuit boards (e.g., a motherboard and one or more daughterboards), batteries, receivers, microphones, sensors, displays, and other components. Housing 108 may be composed of one or more materials such as plastic, aluminum, steel, titanium, gold, composites, alloys of one or more elements, and other materials.

Device 100 includes panel 102. Panel 102 may be a component that covers and/or seals one or more sides of device 100. For instance, panel 102 may be backing of device 100 that covers one or more components of device 100. In another example, panel 102 may be an exterior cover of a display of device 100. Panel 102 may be formed of one or more materials such as glass, ceramic, plastic, and one or more metals, among one or more other materials. Panel 102 may include one or more transparent materials that allow for light in the visible spectrum and/or one or more frequencies of electromagnetic radiation (e.g., infrared light) to pass through panel 102.

Panel 102 may include one or more layers of components. Panel 102 may include one or more components such as a display, touch sensors, fingerprint readers, camera apertures, lasers, and lights, among other components. For example, panel 102 may include a display component that is disposed beneath a glass panel (e.g., between the glass panel and a housing of the computing device). Panel 102 may include the one or more components adhered to a top layer panel.

In some examples, panel 102 may be adhered to housing 108 via one or more adhesive components. For example, panel 102 may include adhesive strips such as strips pressure-sensitive adhesive (PSA) that adhere panel 1202 housing 108. Panel 102 may be adhered to housing 108 via adhesives to hold panel 102 in place and provide protection against water and dust instruction between panel 102 and housing 108.

Panel 102, when attached to housing 108 via adhesives strips, may not enable easy repair of computing device 100. For example, panel 102, when adhered to housing 108, may require a user to apply heat and a cutting tool to separate panel 102 and housing 108. In another example, when being reassembled, panel 102 may require careful attention to align and center panel 102 against housing 108.

In accordance with one or more aspects of this disclosure, panel 102 may be attached to trim subassembly 106 via adhesive component 104. Adhesive component 104 may include one or more types of adhesives such as liquid-dispensed adhesive (LDA), polyurethane, thermosetting polymer, and polyamide adhesive, among other types of adhesive. Adhesive component 104 may also include a gasket used to form a seal against water and dust intrusion into device 100 between panel 102 and trim subassembly 106. For example, adhesive component 104 may include a gasket, foam strip, or other piece of material to which adhesive is applied and used to adhere panel 102 and trim subassembly 106.

Device 100 includes trim subassembly 106 disposed between housing 108 and panel 102. Trim subassembly 106 may include one or more components made of the same or different materials. Trim subassembly 106 includes a compliant component and a non-compliant component. Trim subassembly 106 includes a compliant component that may be made of one or more materials that are compliant in nature such as rubber, moldable plastic, and silicone, among other materials of a compliant nature. Trim subassembly 106 may also include a non-compliant component that may be made of one or more materials of a non-compliant nature such as plastic, metal, composite, and glass, among other materials. Trim subassembly 106, in some examples, may include a compliant component and a non-compliant component that are modeled together as a single subassembly.

Trim subassembly 106 may be inserted into slot 110 of housing 108. Slot 110 may include one or more channels and/or grooves included in one or more sides of housing 108. For example, slot 110 may include a channel that runs along a side of housing 108 that provides a channel into which at least part of trim subassembly 106 can be inserted.

Trim subassembly 106 may be inserted into slot 110 such that the compliant component of trim subassembly 106 is at least partially compressed against one or more sides of slot 110. For example, the compliant component of trim subassembly 106 may expand after being inserted into slot 110 and expand against the interior sides of slot 110. In another example, the compliant component of trim subassembly 106 may expand to curl around a lip of slot 110. The compliant component of trim subassembly 106 may expand around a lip of slot 110 and secure trim subassembly 106 to housing 108.

Trim subassembly 106, when disposed between panel 102 and housing 108, may secure panel 102 to housing 108. For example, trim subassembly 106 may retain panel 102 in a fixed position against housing 108. Trim subassembly 106 may center panel 102 with respect to housing 108. The compliant component of trim subassembly 106, through compression against the sides of slot 110, may center panel 102 with respect to housing 108. The compliant component of trim subassembly 106 may center panel 102 by balancing the pressure against slot 110.

Trim subassembly 106 may seal housing 108 against water and dust intrusion into housing 108. Trim subassembly 106 may seal housing 108 through the compliant component of trim subassembly 106 pressing against the sides of slot 110. For example, the compliant component of trim subassembly 106 may press against the sides of slot 110 and prevent water and dust from passing between slot 110 and the compliant component of trim subassembly 106.

Housing 108 may include receptacle 114. Receptacle 114 may include a circular hole in a side of housing 108 that is threaded along at least a portion of the length of the circular hole in the side of housing 108. Receptacle 114 may also include one or more types of vibration resistant materials such as a vibration resistant adhesive applied to at least a portion of the threaded section of receptacle 114.

Trim subassembly 106 may include bracket 116. Bracket 116 may be attached to or included in the noncompliant component of trim subassembly 106. For example, bracket 116 may be a tab of non-compliant material that extends down from trim subassembly 106 and extends parallel to receptacle 114.

Bracket 116 may include a hole that aligns with the receptacle 114 when trim subassembly 106 is inserted into housing 108. Bracket 116 may include a hole where the interior sides of the hole are threaded with a similar or identical style as receptacle 114. The hole of bracket 116 may also include a vibration resistant material that applied to the threads of the hole of bracket 116.

Bracket 116 and receptacle 114 may be attached to each other via fastener 112. Fastener 112 may be a screw or bolt made of one or more materials. For example, fastener 112 may be made of metal or plastic and threaded through receptacle 114 and bracket 116. Fastener 112 may aid in holding panel 102 and trim subassembly 106 together with housing 108.

The techniques of this disclosure provide one or more technical advantages. For example, instead of requiring panel 102 to be attached to housing 108 via adhesives or adhesive strips such as pressure-sensitive adhesive (PSA) that make it challenging to remove panel 102 without damaging trim, trim subassembly 106 enables easier removal and repairability as no adhesives are used to attach trim subassembly 106 to housing 108. Trim subassembly 106, unlike adhesives, does not require the application of heat and careful prying to remove from housing 108. Further, trim subassembly 106 may obviate the need to replace adhesive strips when panel 102 is removed from housing 108. In another example, the compliant component of trim subassembly 106 enables easier repair by automatically centering panel 102 in reference to housing 108, instead of requiring a user to carefully align panel 102 against housing 108 when installing panel 102 with adhesives. Trim subassembly 106 may automatically center panel 102 and reduce the need to re-align camera modules and camera lenses. In yet another example, trim subassembly 106, through compression of the compliant component of trim subassembly 106 within slot 110, provides protection against water and dust ingress into housing 108.

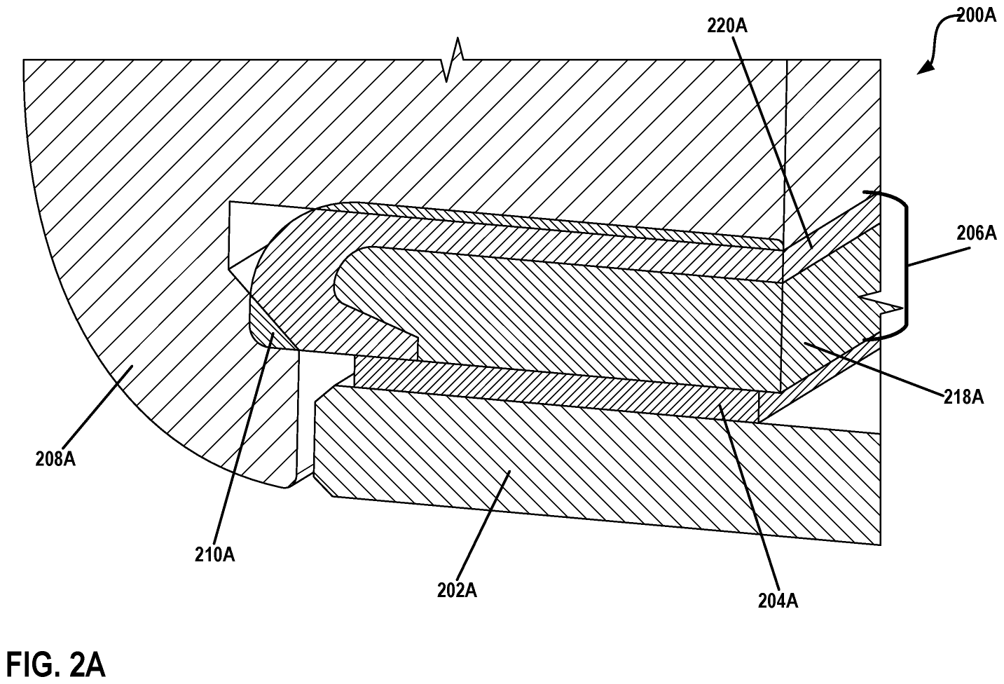

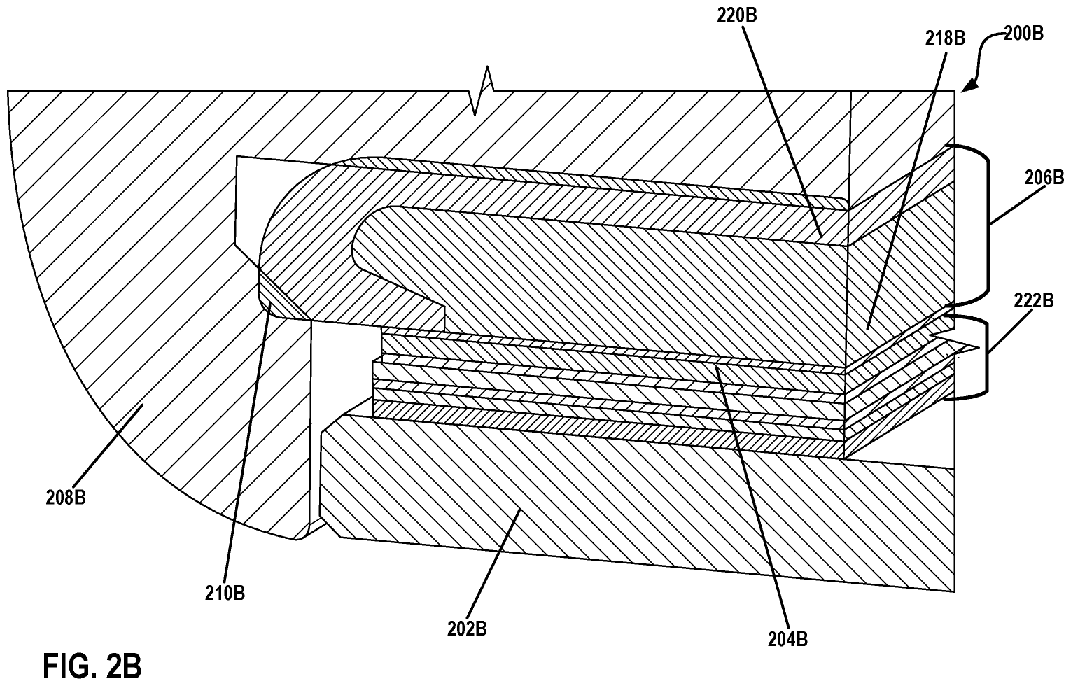

FIG. 2A is a side view schematic diagram illustrating a cross-section of a housing of a device, in accordance with one or more aspects of this disclosure. FIG. 2A illustrates a side of device 200A. Device 200A may be similar to computing device 100 as illustrated in FIG. 1.

Device 200A includes panel 202A. Panel 202A may be a component that covers or seals one or more sides of device 200A. For example, panel 202A may provide a backing of device 200A. In another example, panel 202A may include a display component within panel 202A. Panel 202A may be formed of one or more materials such as glass, ceramic, plastic, composites, and one or more metals, among other materials.

Panel 202A may be attached to trim subassembly 206A via one adhesive component 204A. Adhesive component 204A may include one or more types of adhesives such as liquid-dispensed adhesive (LDA), polyurethane, thermosetting polymer, and polyamide adhesive, among other types of adhesives. Adhesive component 204A may also include a gasket used to form a seal against water and dust intrusion into device 200 between panel 202A and trim subassembly 206A. For example, adhesive component 204A may include a gasket, foam strip, or other piece of material to which adhesive is applied and used to adhere panel 202A and trim subassembly 206A.

Device 200A may include trim subassembly 206A disposed between housing 208A and panel 102A. Trim subassembly 206A may include one or more components made of the same or different materials. As illustrated in FIG. 2A, trim subassembly 206A include non-compliant component 218A and compliant component 220A. Non-compliant component 218A may be formed of one or more types of non-compliant materials such as one or more metals, types of rigid plastic, composites such as carbon fiber, or other types of non-compliant material. Trim subassembly 206A may include non-compliant component 218A to add rigidity to trim subassembly 206A.

Trim subassembly 206A may include compliant component 220A. Compliant component 220A may be disposed between non-compliant component 218A and housing 208A. For example, compliant component 218A may be disposed between housing 208A and non-compliant component 218A. In another example, trim subassembly 206A may include a gasket that is located at least in part between non-compliant component 218A and compliant component 220A. In another example, non-compliant component 218A and compliant component 220A are molded together as a single assembly.

Trim subassembly 206A may be inserted into slot 210A of housing 208A. Slot 210A of housing 208A may include one or more channels and/or grooves included in one or more sides of housing 208A. For example, as illustrated in FIG. 2A, slot 210A provides a channel into which at least a part of trim subassembly is inserted into.

Trim subassembly 206A may be inserted into housing 208A such that compliant component 220A is at least partially inserted into slot 210A. Compliant component 220A may be at least partially compressed within slot 210A and pressed against one or more sides of slot 210A. For example, as illustrated in FIG. 2A, compliant component 220A fills slot 210A. In another example, compliant component 220A expands to curl around a lip of slot 210A.

Trim subassembly 206A, when disposed between panel 202A and housing 208A, may secure panel 202A to housing 208A. For example, trim subassembly 206A may retain panel 202A in a fixed position against housing 208A. Compliant component 220A, by expanding against one or more sides of slot 210A and equalizing the pressure against the one or more sides, may center panel 202A with respect to housing 208A. Compliant component 220A may center panel 202A by balancing the pressure against the sides of slot 210A.

Compliant component 220A of trim subassembly 206A may seal housing 108 against water and dust intrusion between panel 202A and housing 208A. For example, compliant component 220A may press against the sides of slot 210A and prevent water and dust passing between slot 210A and compliant component 208A. Compliant component 220 may provide a seal against water and dust intrusion while not requiring application of heat or a cutting implement to be removed from computing device 200A.

FIG. 2B is a side view schematic diagram illustrating a cross-section of a portion of a housing of a computing device, in accordance with one or more aspects of this disclosure. FIG. 2B illustrates a side of device 200B, which may be substantially similar to device 200A as illustrated by FIG. 2A.

Device 200B includes panel 202B. Panel 202B, similar to panel 202A, may be a component that covers or seals one or more sides of device 200B. For example, panel 202B may provide a backing of device 200B. Panel 202B may be made of one or more materials such as glass, ceramic, or other materials.

Component stack 222B may be disposed between panel 202B and adhesive component 204B. Component stack 222B may include one or more components that form one or more layers of components between panel 202B and adhesive component 204B. Component stack 222B may include one or more components such as display, touch components, wireless charging components such as a charging coil, or other components. For example, component stack 222B may include a display and one or more capacitive touch components disposed between panel 202B and trim subassembly 206B. Component stack 222B may be attached to panel 202B to form an assembly of panel 202B and component 222B. In another example, component stack 222B includes a wireless charging coil and one or more magnets attached to panel 202B. Component stack 222B and panel 202B may be attached to a side of housing 208B that is opposite that of device 200B.

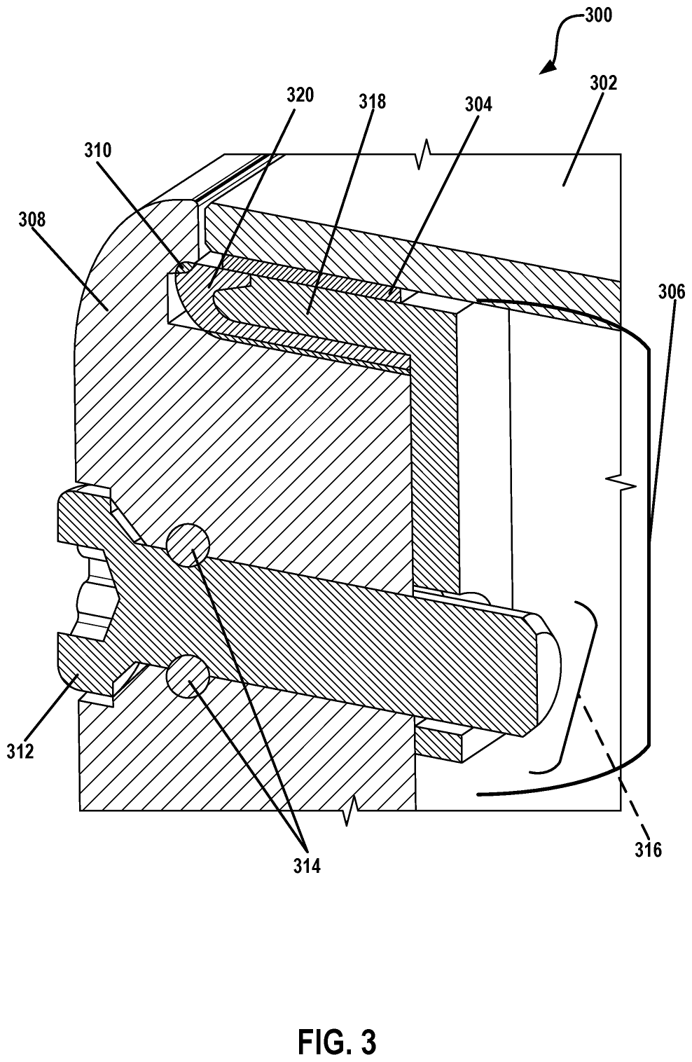

FIG. 3 is a side view schematic diagram illustrating a cross-section of a portion of a housing of a computing device that includes a fastener, in accordance with one or more aspects of this disclosure. FIG. 3 illustrates a side of device 300.

Device 300 may include panel 302. Panel 302 may be a component that covers or seals one or more sides of a device. For example, panel 302 may provide a backing of device 300. In another example, 302 may include a display component within panel 302. Panel 302 may be formed of one or more materials such as glass, ceramic, plastic, composites, and metal. Panel 302 may be similar to panel 102 as illustrated in FIG. 1, panel 202A as illustrated in FIG. 2A, or panel 202B as illustrated in FIG. 2B.

Panel 302 may be attached to trim subassembly 306 via adhesive component 304. Adhesive component 304 may include one or more types of adhesives such as liquid-dispensed adhesive (LDA), polyurethane, thermosetting polymer, and polyamide adhesive, among other types of adhesives. Adhesive component 304 may be similar to adhesive component 104 as illustrated in FIG. 1, adhesive component 204A as illustrated in FIG. 2A, or adhesive component 204B as illustrated in FIG. 2B.

Device 300 may include trim subassembly 306 disposed between housing 308 and panel 302. Trim subassembly 306 may include one or more components made of the same or different materials. As illustrated in FIG. 3, trim subassembly includes non-compliant component 318 and compliant component 320. Trim subassembly 306 may be similar to trim subassembly 106 as illustrated in FIG. 1, trim subassembly 206A as illustrated in FIG. 2A, or trim subassembly 206B as illustrated in FIG. 2B.

Trim subassembly 306 may include non-compliant component 318. Non-compliant component 318 may be formed of one or more types of non-compliant materials such as one or more metals, types of rigid plastic, composites such as carbon fiber, or other types of non-compliant material. Non-compliant component 318 may be similar to non-compliant component 118 as illustrated in FIG. 1, non-compliant component 218A as illustrated in FIG. 2A, or non-compliant component 218B as illustrated in FIG. 2B.

Non-compliant component 318 may include bracket 316. Bracket 316 may be a component of non-compliant component 318 and made of similar materials as non-compliant component 318. In an example, bracket 316 is a separate component attached to non-compliant component 318. In another example, bracket 316 is an extension of non-compliant component 318 instead of being a separate component attached to non-compliant component 318.

Bracket 316 may include one or more components that enable retention of trim subassembly 306 to housing 308. For example, bracket 316 may include one or more snaps that are inserted into housing 308 and increase the adherence of trim subassembly 306 to housing 308. In another example, bracket 316 may make use of a tray, such as a SIM tray, to increase the adherence of trim subassembly 306 to housing 308.

Bracket 316 may include one or more sections of threaded material. For example, bracket 316 may include a section that is threaded (e.g., tapped) to enable a screw or other fastener to grip bracket 316 along the threaded section of bracket 316. For example, bracket 316 may include a hole in a planar section of bracket 316, where the interior of the hole is threaded to accept the threads of a fastener. In another example, bracket 316 may include a threaded section within a predetermined distance from a terminating end of bracket 316. In some examples, bracket 316 may include one or more types of nuts and washers. Bracket 316 may include a threaded section to enable a fastener, such as fastener 312, to be attached to bracket 316 and assist in securing panel 302 to housing 308. For example, bracket 316 may include a nut such as a locking nut into which the fastener is threaded. In some examples, bracket 316 may include one or more washers attached to bracket 316.

Housing 308 and trim subassembly 306 may be connected via fastener 312. Fastener 312 may be one or more types of fasteners such as a screw, bolt, rivet, barbed rod, threaded rod, carriage bolt, set screw, or other type of fastener. Fastener 312 may be made of one or more materials such as metal, plastic, rubber, or other materials. For example, fastener 312 may be a steel screw.

Fastener 312 may be inserted into receptacle 314, which may be included in housing 308. Receptacle 314 may be a circular hole that runs from an exterior side of housing 308 to an interior side of housing 308. For example, receptacle 314 may include a hole with two terminating ends, with one terminating end located at an interior end of housing 308 (e.g., terminating at the interior space of housing 308 covered by panel 302

Fastener 312 may further secure panel 302 to housing 308 in addition to the attachment of trim subassembly 306 to housing 308. For example, fastener 312 may be inserted into receptacle 314 and bracket 316, and may prevent bracket 316 (and by extension trim subassembly 306) from moving apart from housing 308. Device 300 may include bracket 316 and fastener 312 to provide further retention of panel 302. In an example, device 300 is a ruggedized sports watch that experiences regular hard impacts and other stress. Bracket 316 and fastener 312 provide additional retention of panel 302 to ensure that panel 302 does not become dislodged during the heavy use of device 300.

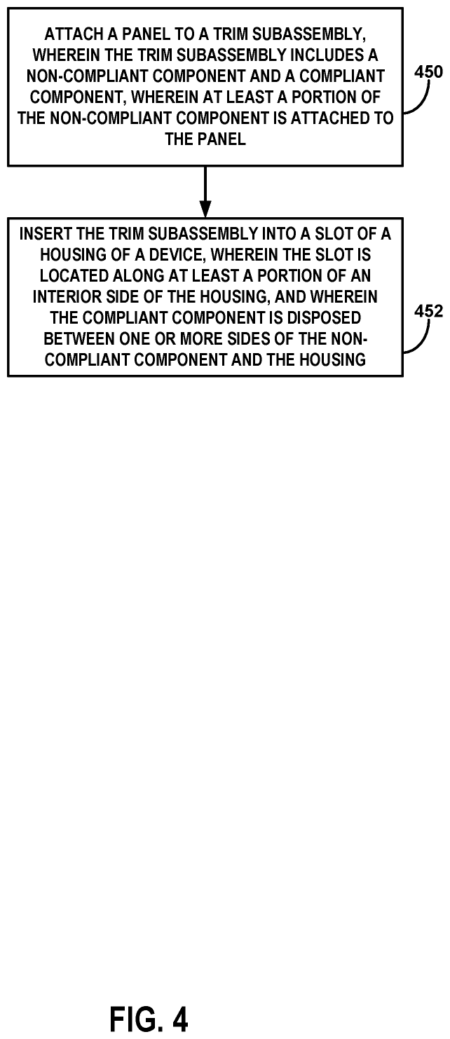

FIG. 4 is a flow chart illustrating a method of forming an assembly of a device, in accordance with one or more aspects of this disclosure. For the purposes of clarity, FIG. 4 is discussed in reference to FIG. 2.

An assembler may attach a panel, such as panel 202A, to a trim subassembly, such as trim subassembly 206A, wherein trim subassembly 206A includes a non-compliant component, such as non-compliant component 218A, and a compliant component, such as compliant component 220A, wherein at least a portion of non-compliant component 218A is attached to panel 202A (450). The assembler may attach panel 202A to trim subassembly 206A via adhesive component 204A. For example, the assembler may attach panel 202A to trim subassembly 206A using adhesive component 204A comprising Liquid-Dispensed Adhesive applied between panel 208A and trim subassembly 206A.

The assembler may insert trim subassembly 206A into a slot, such as slot 210A of a device, wherein slot 210A is located along at least a portion of an interior of housing 208A, wherein compliant component 220A is disposed between one or more sides of non-compliant component 218A and housing 208A (452). Compliant component 220A may deform into slot 210A and equalize pressure among the sides of slot 210A.

Example 1: A computing device includes a housing, wherein the housing includes a slot along at least a portion of an interior side of the housing; a panel; and a trim subassembly, wherein the trim subassembly includes a non-compliant component and a compliant component, wherein at least a portion of the non-compliant component is attached to the panel, wherein the compliant component is inserted into the slot of the housing, and wherein the compliant component is disposed between one or more sides of the non-compliant component and the housing.

Example 2: The computing device of example 1, wherein the compliant component deforms into the slot to provide a seal against at least one of water or dust intrusion into the housing.

Example 3: The computing device of example 1, wherein the panel comprises a display component.

Example 4: The computing device of example 1, wherein the trim subassembly is adhered to the panel with adhesive.

Example 5: The computing device of example 1, further includes a screw that attaches the housing and the trim subassembly.

Example 6: The computing device of example 1, wherein the non-compliant component and the compliant component are molded together as a single subassembly.

Example 7: The computing device of example 1, wherein the non-compliant component and the compliant component are attached to each other at least in part by a gasket located at least in part between the non-compliant component and the compliant component.

Example 8: The computing device of example 1, wherein the slot is a first slot, wherein the trim subassembly is a first trim subassembly, the panel is a first panel, and where the computing device includes a second trim subassembly and a second panel, and wherein the compliant component of the second trim subassembly is inserted into a second slot of the housing.

Example 9: The computing device of example 1, wherein the trim subassembly and the housing are not attached using presence-sensitive adhesive.

Example 10: The computing device of example 1, wherein the compliant component is formed at least in part of liquid silicone rubber.

Example 11: A method includes attaching a panel to a trim subassembly, wherein the trim subassembly includes a non-compliant component and a compliant component, wherein at least a portion of the non-compliant component is attached to the panel; and inserting the trim subassembly into a slot of a housing of a device, wherein the slot is located along at least a portion of an interior side of the housing, and wherein the compliant component is disposed between one or more sides of the non-compliant component and the housing.

Example 12: The method of example 11, further includes forming the compliant component against the housing to provide a seal against at least one of water intrusion or dust intrusion into the housing.

Example 13: The method of example 11, further includes attaching a display component to the panel.

Example 14: The method of example 11, further comprising adhering the trim subassembly to the panel with liquid dispensed adhesive.

Example 15: The method of example 11, further comprising attaching the housing and the trim subassembly with a screw.

Example 16: The method of example 11, further comprising molding the non-compliant component and the compliant together as a single assembly.

Example 17: A kit for attaching a panel to a housing of a computing device that includes the panel, wherein the panel is attached to a trim subassembly, wherein the trim subassembly includes a non-compliant component and a compliant component, wherein at least of a portion of the non-compliant component is attached to the panel; and a housing, wherein the housing includes a slot along at least a portion of an interior side of the housing, wherein the compliant component is inserted into the slot of the housing, and wherein the compliant component is disposed between one or more sides of the housing.

Example 18: The kit of example 17, wherein the panel includes a display component.

Example 19: The kit of example 17, wherein the housing includes at least one of one or more circuit boards, a battery, or one or more sensors.

Various aspects have been described in this disclosure. These and other aspects are within the scope of the following claims.

What is claimed is:

1. A computing device comprising:
a housing, wherein the housing includes a slot along at least a portion of an interior side of the housing;
a panel; and
a trim subassembly, wherein the trim subassembly includes a non-compliant component and a compliant component, wherein at least a portion of the non-compliant component is attached to the panel, wherein the compliant component is inserted into the slot of the housing, and wherein the compliant component is disposed between one or more sides of the non-compliant component and the housing.

2. The computing device of claim 1, wherein the compliant component deforms into the slot to provide a seal against at least one of water or dust intrusion into the housing.

3. The computing device of claim 1, wherein the panel comprises a display component.

4. The computing device of claim 1, wherein the trim subassembly is adhered to the panel with adhesive.

5. The computing device of claim 1, further comprising:
a screw that attaches the housing and the trim subassembly.

6. The computing device of claim 1, wherein the non-compliant component and the compliant component are molded together as a single subassembly.

7. The computing device of claim 1, wherein the non-compliant component and the compliant component are attached to each other at least in part by a gasket located at least in part between the non-compliant component and the compliant component.

8. The computing device of claim 1, wherein the slot is a first slot, wherein the trim subassembly is a first trim subassembly, the panel is a first panel, and where the computing device includes a second trim subassembly and a second panel, and wherein the compliant component of the second trim subassembly is inserted into a second slot of the housing.

9. The computing device of claim 1, wherein the trim subassembly and the housing are not attached using presence-sensitive adhesive.

10. The computing device of claim 1, wherein the compliant component is formed at least in part of liquid silicone rubber.

11. A method, comprising:
attaching a panel to a trim subassembly, wherein the trim subassembly includes a non-compliant component and a compliant component, wherein at least a portion of the non-compliant component is attached to the panel; and
inserting the trim subassembly into a slot of a housing of a device, wherein the slot is located along at least a portion of an interior side of the housing, and wherein the compliant component is disposed between one or more sides of the non-compliant component and the housing.

12. The method of claim 11, further comprising:
forming the compliant component against the housing to provide a seal against at least one of water intrusion or dust intrusion into the housing.

13. The method of claim 11, further comprising:
attaching a display component to the panel.

14. The method of claim 11, further comprising adhering the trim subassembly to the panel with liquid dispensed adhesive.

15. The method of claim 11, further comprising attaching the housing and the trim subassembly with a screw.

16. The method of claim 11, further comprising molding the non-compliant component and the compliant together as a single assembly.

17. A kit for attaching a panel to a housing of a computing device, the kit comprising:
the panel, wherein the panel is attached to a trim subassembly, wherein the trim subassembly includes a non-compliant component and a compliant component, wherein at least of a portion of the non-compliant component is attached to the panel; and
a housing, wherein the housing includes a slot along at least a portion of an interior side of the housing, wherein the compliant component is inserted into the slot of the housing, and wherein the compliant component is disposed between one or more sides of the housing.

18. The kit of claim 17, wherein the panel includes a display component.

19. The kit of claim 17, wherein the housing includes at least one of:
one or more circuit boards,
a battery, or
one or more sensors.
